(19) United States
(12) Patent Application Publication
(10) Pub. No.: US 2022/0405040 A1
(43) Pub. Date: Dec. 22, 2022

(54) HEADPHONE-ONLY AUDIO OPTIONS

(71) Applicant: Hewlett-Packard Development Company, L.P., Spring, TX (US)

(72) Inventor: Isaac Lagnado, Spring, TX (US)

(21) Appl. No.: 17/352,598

(22) Filed: Jun. 21, 2021

(51) Int. Cl. G06F 3/16; H04R 29/00; G10L 25/51; H04R 3/00; H04R 1/10; H04L 29/06; G01S 19/42

(52) U.S. Cl. CPC G06F 3/162; H04R 29/004; G10L 25/51; H04R 3/00; H04R 1/1041; H04L 65/403; G01S 19/42; H04R 2420/05; H04R 2460/07; H04R 2420/03; G06F 9/445

(57) ABSTRACT

An example computing device is provided. The computing device includes an interface to connect to a headphone and a processor communicatively coupled to the interface. The processor is to execute an application to hos an audio call, determine a headphone-only audio option is enabled for the application, detect that the headphone is connected to the interface, and allow a participant to join the audio call based on detection of the headphone connected to the interface.

### BACKGROUND

As more workers work from home, video conferencing has become a popular choice for communicating or holding meetings. Applications can be executed on computing devices to host video conferences or virtual meetings that allow users to communicate with one another and that may include video in addition to the audio. The applications may allow users to share screens and/or data on a screen. Thus, these types of video conferencing applications can be very productive.

### BRIEF DESCRIPTION OF THE DRAWINGS

FIG. 1 is a block diagram of an example computing device that can execute an application based on detection of a headphone connection of the present disclosure;

FIG. 2 is a block diagram of an example computing device of the present disclosure that can use a microphone to confirm that the connection is detected to a headphone to allow a user to participate in a call hosted by an application;

FIG. 3 is a block diagram of an example computing device of the present disclosure that can use location information to enable a headphone-only option for an application;

FIG. 4 is a flow chart of an example method for executing an application based on detection of headphones of the present disclosure;

FIG. 5 is an example non-transitory computer readable storage medium storing instructions executed by a processor to execute an application based on detection of headphones of the present disclosure; and

FIG. 6 is an example non-transitory computer readable storing instructions executed by a processor to execute an application based on detection of headphones at a headphone-only location of the present disclosure.

### DETAILED DESCRIPTION

Examples described herein provide a computing device to control an application based on detection of headphones. As discussed above, applications can be executed on computing devices to host video conferences or virtual meetings that allow users to communicate with one another and that may include video in addition to the audio. The applications may allow users to share screens and/or data on a screen. Thus, these types of video conferencing applications can be very productive.

However, some users may participate in these calls or virtual meetings from unsecure locations. The topics for discussion may include sensitive materials of an enterprise or company that should not be available to the public. In other example, a participant who is hosting the call may not want others to hear the conversation. As a result, some participants may want to ensure that the audio output of another participant on the call is kept private by ensuring that the other participants are using headphones to listen to the audio output from the call.

The present disclosure provides an apparatus that can control an application based on detection of a headphone for audio output of the application. For example, the application may be modified to allow a host participant to enable a setting in the application that prevents invited participants from joining the call if headphones are not connected to the invited participants' computing devices. In an example, a headphone-only audio driver may be stored on the computing device as part of an install package for the application. As a result, when a headphone-only setting is enabled, the application may apply the headphone-only audio driver to the audio devices of computing devices of invited participants.

In another example, an enterprise may change basic input/output system (BIOS) settings to allow audio from an application if a headphone connection is detected. An information technology (IT) administrator may select which applications may require headphone only audio output.

In some examples, a microphone may be used to ensure that the connection is to a headphone and not to a speaker. For example, a microphone may be activated to listen for audio generated by the application. If the audio is detected via the microphone, then the participant may be removed from the call hosted by the application until the participant connects headphones to the computing device.

In an example, location information may be used to selectively enable the headphone-only audio option. For example, the headphone-only audio option for the application may be enabled when the participant is at any location other than the participant's home or office location. In another example, the headphone-only audio option may be enabled when located in a library or a conference room in an office building, and so forth. Thus, the present disclosure allows applications to be controlled based on detection of headphones.

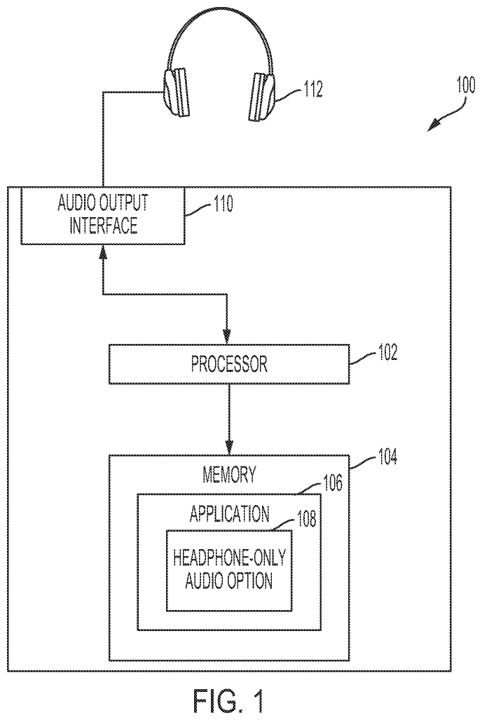

FIG. 1 illustrates an example of a computing device 100 to execute an application based on detection of a headphone connection of the present disclosure. The computing device 100 may be a desktop computer, a mobile computer, a laptop computer, a tablet device, a smart phone, and the like.

In an example, the computing device 100 may include a processor 102, a memory 104, and an audio output interface 110. However, it should be noted that the computing device 100 has been simplified for ease of explanation. For example, the computing device 100 may include additional components that are not shown, such as a display device, input devices (e.g., a mouse, a trackpad, a keyboard, and the like), additional interfaces (e.g., a universal serial bus (USB) interface), a wired or wireless communication interface (e.g., an Ethernet port, a WiFi network card, and the like) to communicate over the Internet, and the like.

In an example, the processor 102 may be communicatively coupled to the memory 104 and the audio output interface 110. The processor 102 may execute instructions stored in the memory 104 to perform the functions described herein.

In an example, the memory 104 may be any type of non-transitory computer readable medium. For example, the memory 104 may be a hard disk drive, a solid-state drive, a random access memory (RAM), a read-only memory (ROM), and the like.

The memory 104 may store an application 106 that is executed by the processor 102. The application 106 may be an application that can host a video call with audio or an audio call. For example, participants may connect on the audio call with their respective computing devices 100 and speak to one another via the application 106.

As discussed above, there may be some instances where the audio output from the application 106 should be private. In other words, the audio output should be directed to a headphone 112 that is connected to the audio output interface 110 such that others around the participant cannot hear the audio output from the application 106. Said another way, the audio output from the application 106 should not be provided to the internal speakers (not shown) of the computing device 100 or any external speakers that may be connected to the computing device 100.

The computing device 100 may control execution of the application 106 based on detection of a connection to the headphones 112 when a headphone-only audio option 108 is enabled. For example, a host that creates the audio call via the application 106 may include a headphone-only audio option as part of the invitation. When the computing device 100 receives the invitation for the audio call, the application 106 stored in the memory 104 may activate the headphone-only audio option 108.

When the processor 102 executes the application 106 to join the audio call, the processor 102 may determine that the headphone-only audio option 108 has been enabled in the application 106. The processor 102 may then communicate with the audio output interface 110 to detect whether the headphones 112 have been connected. If a connection to headphones 112 is detected, then the processor 102 may provide a confirmation to the application 106 indicating headphones are connected, and the application 106 may allow the participant to join the audio call.

In an example, when the processor 102 determines that the headphone-only audio option 108 has been enabled, the processor 102 may switch the audio output to the audio output interface 110. The processor 102 may wait for a connection to the headphones 112 before the application 106 allows the participant to join the audio call.

In an example, the audio output interface 110 may be a wired or wireless interface. For example, the audio output interface 110 may be a headphone output audio jack to establish a wired connection to the headphones 112.

In another example, the audio output interface 110 may be a wireless interface such as a Bluetooth interface. In an example, the processor 102 may receive confirmation that the headphones 112 are connected based on information exchanged between the headphones 112 and the audio output interface 110 when the headphones 112 are initially connected. For example, the wireless connection may receive information associated with the headphones 112, such as model information, media access control (MAC) identification information, and the like. This information may be forwarded to the processor 102 to confirm that the headphones are connected.

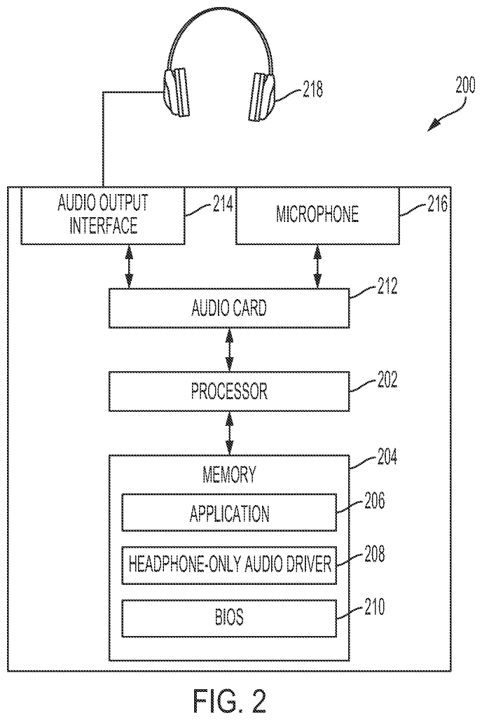

In some instances, a user may try to “trick” the computing device 100 into believing that the headphones 112 are connected. For example, a user may connect an external speaker to the audio output interface or may leave the headphones 112 off with the volume turned up. An example computing device 200 is illustrated in FIG. 2 to prevent participants from avoiding the headphone-only audio option.

FIG. 2 illustrates an example computing device 200 that can use a microphone 216 to confirm the connection to headphones 218. The computing device 200 may be a desktop computer, a mobile computer, a laptop computer, a tablet device, a smart phone, and the like. The computing device 200 may be similar to the computing device 100. For example, the computing device 200 may include a processor 202, a memory 204, and an audio output interface 214.

FIG. 2 illustrates some additional details for the computing device 200. For example, the computing device 200 may have an audio card 212. The audio card 212 may be discrete audio card or an integrated audio card. The audio card 212 may convert analog audio signals captured by the microphone 216 and convert the audio into digital signals that can be processed by the processor 202. The audio card 212 may also convert digital signals from the processor 202 into analog audio signals that can be output through the audio output interface 214.

In an example, the memory 204 may store an application 206, a headphone-only audio driver 208, and a basic input/output system (BIOS) 210. Although a single memory 204 is illustrated in FIG. 2, it should be noted that multiple memory devices may be included in the computing device 200. For example, the BIOS 210 may be stored on a separate secure memory device.

As used herein, a BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the application 206 may be an application to host a video call with audio or an audio call. The application 206 may include a headphone-only audio option similar to the headphone-only audio option 108 illustrated in FIG. 1. In an example, the computing device 200 may receive an invitation from a host of an audio call. The invitation may include a request or a setting to activate a headphone-only audio option on the application 206. In response, the processor 202 may check the audio output interface 214 to confirm that a connection to the headphones 218 is detected.

As noted above, a user may not want to use the headphones 218 and may try to circumvent the headphone-only audio option and use speakers. For example, the user may connect a speaker that includes a plug that fits into the audio output interface 214 or may modify the information from a wireless speaker to make it appear as if the speaker is a headphone when connected to the audio output interface 214.

However, the microphone 216 may monitor for audio to confirm that the headphones 218 are connected. Audio captured by the microphone 216 may be provided to the processor 202. The processor 202 may analyze the captured audio to determine if any of the captured audio matches audio generated by the application 206. In other words, if the microphone 216 captures audio that matches audio outputted by the application 206, then the processor 202 may determine that the connection is not to the headphones 218. For example, the participant may have connected a speaker or the participant may not be wearing the headphones 218 to prevent audio from escaping and being heard by others.

In response, the processor 202 may prevent the participant from joining the audio call or may remove the participant from the audio call. In addition, the processor 202 may generate a notification on a display device connected to the computing device 200. The notification may let the participant know that a connection to headphones 218 is not detected or that the headphones 218 are not being worn properly such that others may not hear the audio from the audio call.

In an example, the headphone-only audio driver 208 may be installed in the memory 204 as part of the installation of the application 206. For example, a third-party application developer of the application 206 may also create the headphone-only audio driver 208. When the headphone-only audio option is enabled, the application 206 may cause the processor 202 to use the headphone-only audio driver 208 to control operation of the audio card 212. The headphone-only audio driver 208 may provide instructions to the audio card 212 such that the audio card 212 disables ports used for external speakers while the application 206 is being executed. In addition, the headphone-only audio driver 208 may generate a connection signal when a connection to headphones 218 is detected. The connection signal may be provided to the processor 202, which in turn may notify the application 206 to authorize the participant to join the call.

In another example, some third-party application developers may not want to provide a software option to enable the headphone-only audio option. As a result, an enterprise or information technology (IT) administrator may make modifications to the BIOS 210 to control audio output for select applications. For example, the BIOS 210 may be modified to define applications that should execute with headphone-only audio outputs. For example, the IT administrator may enable the headphone-only audio output for audio call and video call applications, but may not require them for music applications or video streaming applications.

In an example, the BIOS 210 may be modified to include a headphone-only audio option. When the headphone-only audio option is enabled, the BIOS 210 may disable audio outputs except for the audio output interface 214 that connect to the headphones 218. For example, onboard speakers may be disabled or any other external speakers that may be connected to the computing device 200 may be disabled.

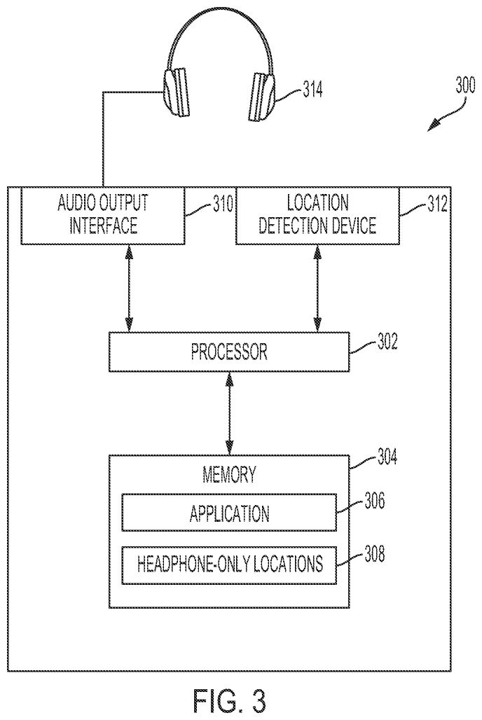

FIG. 3 illustrates a block diagram of another example of a computing device 300 to enable a headphone-only option for an application based on a location of the present disclosure. In an example, the computing device 300 may be similar to the computing devices 100 and 200. For example, the various components of the computing devices 100 and 200 may also be included in the computing device 300.

In an example, the computing device 300 may include a processor 302, a memory 304, an audio output interface 310, and a location detection device 312. The processor 302 may be communicatively coupled to the memory 304, the audio output interface 310, and the location detection device 312. The processor 302 may execute instructions stored in the memory 304. The processor 302 may also control operation of, or receive data collected by, the audio output interface 310 and the location detection device 312.

In an example, the memory 304 may store an application 306 and a list of headphone-only locations 308. The application 306 may be an application to host a video call with audio or an audio call, as described above. The application 306 may also include the headphone-only audio option 108 illustrated in FIG. 1, and described above.

In some examples, the headphone-only audio option 108 may be enabled based on a location of the computing device 300. For example, the computing device 300 may be a mobile device or a laptop computer. It may be undesirable to use external audio in some locations. For example, external audio may be prohibited in a library, in public coffee shops, in conference rooms on a campus of an enterprise, at an open cubicle in an office building, and the like. The headphone-only locations 308 may list locations where the headphone-only audio option should be enabled.

In an example, the headphone-only locations 308 may be defined by the third-party application developer of the application 306. In an example, the headphone-only locations 308 may be defined by an IT administrator of an enterprise. In an example, the headphone-only locations 308 may be defined by the location. For example, when a user logs onto the Wi-Fi at a location, part of the agreement to join the public Wi-Fi at the location may include an agreement to use headphones for audio. The location may be added to the headphone-only locations 308.

In an example, the location detection device 312 may detect a location of the computing device 300 and may determine if the location is listed in the headphone-only locations 308. If the location is found, then the processor 302 may enable the headphone-only audio option. The headphone-only audio option may be enabled using a headphone-only audio driver or using settings in the BIOS, as illustrated in FIG. 2, and described above.

The location detection device 312 may be any type of location detection device. In an example, the location detection device 312 may be a global positioning system (GPS) radio. The GPS coordinates of the mobile device 300 may be correlated to a building or a particular location that may be included in the headphone-only locations 308.

In an example, the location detection device 312 may be a wireless radio. For example, the wireless radio may be a Wi-Fi network card. The network identification of a particular Wi-Fi network may be used to determine the location of the mobile device 300. In another example, the wireless radio may determine a location of the mobile device 300 by triangulating a position of the mobile device 300 based on radio signals received from nearby base stations or access points.

Thus, the present disclosure may execute an application based on a connection to headphones when a headphone-only audio option is enabled. The option may be requested by a host of an audio call or may be enabled based on a location of the computing device. The connection may be monitored by a microphone to ensure that the headphones are connected. If the headphone connection is confirmed, the participant may be authorized to join the audio call or remain on the audio call.

The connection may be continuously monitored. As a result, if a participants decides to change the audio output to speakers during the audio call when the headphone-only audio option is enabled, the application may boot the participant from the audio call, or prevent the audio stream from being transmitted, until the headphone connection is detected again.

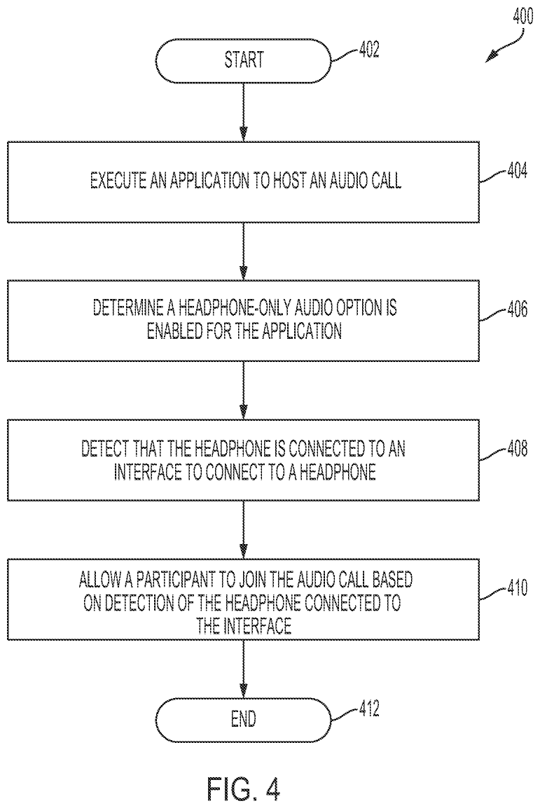

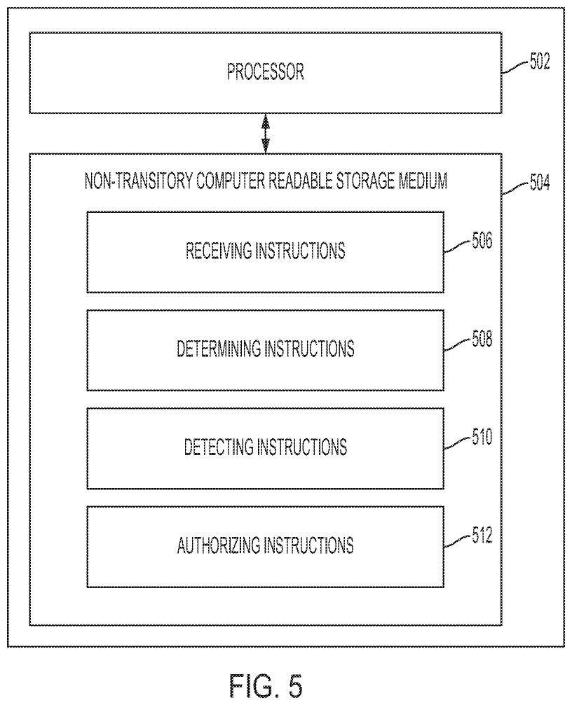

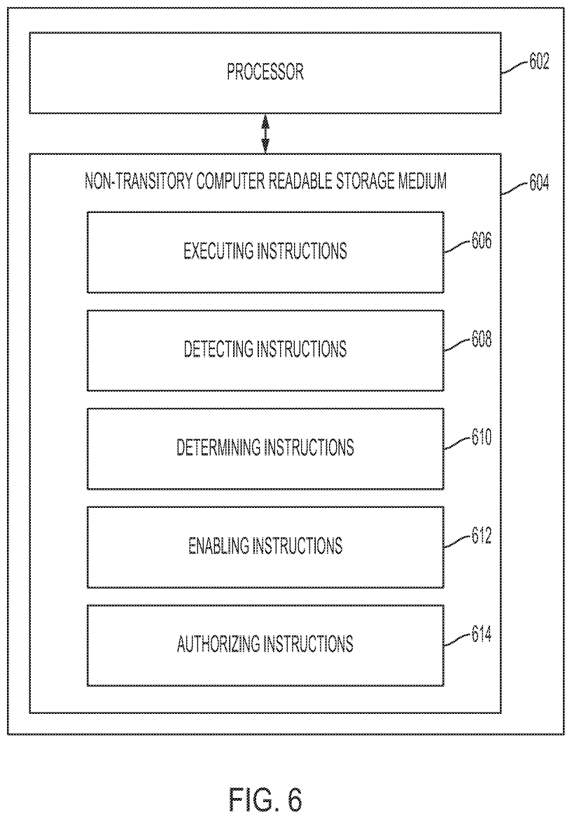

FIG. 4 illustrates a flow diagram of an example method 400 for executing an application based on detection of headphones. In an example, the method 400 may be performed by the computing devices 100, 200, 300, the apparatus 500 illustrated in FIG. 5, and described below, or the apparatus 600 illustrated in FIG. 6, and described below.

At block 402, the method 400 begins. At block 404, the method 400 executes an application to host an audio call. For example, a participant may receive an invitation to join an audio call. When the invitation is opened, the invitation may cause the application associated with the audio call to be executed on a computing device of the participant.

At block 406, the method 400 determines that a headphone-only audio option is enabled for the application. In an example, the host of the audio call may request that the headphone-only audio option be enabled.

In another example, the headphone-only audio option may be enabled based on a location of the computing device. For example, a GPS signal or network identification information may be used to determine the location of the computing device. If the location matches a location on a list of headphone-only locations, then the headphone-only audio option may be enabled for the application.

At block 408, the method 400 detects that a headphone is connected to an interface (e.g., an audio output interface) of the computing device to connect a headphone. For example, for a wired connection, the method 400 may detect the headphone connection when a headphone jack is inserted into a headphone out port. For a wireless connection, the computing device may collect information when the headphone is initially connected that indicates the connected device is a headphone. For example, the information may include a model number of MAC ID number associated with headphones.

At block 410, the method 400 allows a participant to join the audio call based on detection of the headphone connected to the interface. That is, when the headphone connection is detected, the participant may be authorized to join the audio call.

In an example, the method 400 may continue to monitor the audio output via audio signals captured by a microphone. When the audio signals captured by a microphone include audio that matches audio output generated by the audio call, the participant may be disconnected from the audio call, or the audio stream may be discontinued. A notification may be generated to notify the participant to re-connect the headphones, wear the headphones, or lower the volume on the headphones such that audio does not escape from the headphones. At block 412, the method 400 ends.

FIG. 5 illustrates an example of an apparatus 500. In an example, the apparatus 500 may be the computing device 100. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include receiving instructions 506. For example, the instructions 506 may receive an invitation to participate on an audio call executed by an application.

The instructions 508 may include determining instructions. For example, the instructions 508 may determine that the invitation has a headphone-only audio option enabled by a host of the audio call. The enabled headphone-only audio option may be controlled via a headphone-only audio driver that is downloaded as part of the installation of the application or settings in the BIOS of the apparatus 500.

The instructions 510 may include detecting instructions. For example, the instructions 510 may detect a headphone connected to an audio output interface.

The instructions 512 may include authorizing instructions. For example, the instructions 512 may authorize a participant to join the audio call in response to detection of the headphone connected to the audio output interface.

FIG. 6 illustrates an example of an apparatus 600. In an example, the apparatus 600 may be the computing device 100. In an example, the apparatus 600 may include a processor 602 and a non-transitory computer readable storage medium 604. The non-transitory computer readable storage medium 604 may include instructions 606, 608, 610, 612, and 614 that, when executed by the processor 602, cause the processor 602 to perform various functions.

In an example, the instructions 606 may include executing instructions 606. For example, the instructions 606 may execute an application to host an audio call.

The instructions 608 may include detecting instructions. For example, the instructions 608 may detect a location of the computing device. The location may be determined based on a GPS signal or a network identification of a wireless or wired network connected to the apparatus 600.

The instructions 610 may include determining instructions. For example, the instructions 610 may determine that the location is a headphone-only location for the application. For example, the location can be compared to a list of headphone-only locations that is stored in the non-transitory computer readable storage medium 604 of the apparatus 600.

The instructions 612 may include enabling instructions. For example, the instructions 612 may enable a headphone-only audio option for the application in response to a determination that the location is a headphone-only location.

The instructions 614 may include authorizing instructions. For example, the instructions 614 may authorize a participant to join the audio call when a headphone is connected to the computing device.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
an interface to connect to a headphone; and
a processor communicatively coupled to the interface, wherein the processor is to:
execute an application to host an audio conference call;
determine a headphone-only audio option is enabled for the application, wherein the headphone-only option is enabled by a host of the audio conference call via a setting in an invitation for the audio conference call;
detect that the headphone is connected to the interface; and
allow a participant to join the audio conference call based on detection of the headphone connected to the interface.

2. The computing device of claim 1, further comprising:
an audio card, wherein the processor is to load a headphone-only audio driver stored in memory to operate the audio card while the application is executed.

3. The computing device of claim 2, wherein the headphone-only audio driver is to cause the audio card to disable ports used for external speakers while the application is executed.

4. The computing device of claim 1, further comprising:
a memory to store basic input/output system (BIOS) settings that include a selection of applications for which to enable the headphone-only audio option and which are allowed to execute when a headphone connection to the interface is detected.

5. (canceled)

6. The computing device of claim 1, further comprising:
a microphone to detect audio output from the audio conference call of the application, wherein detection of the audio output causes the application to remove the participant from the audio conference call.

7. The computing device of claim 1, further comprising:
a location detection device to detect a location of the computing device wherein the headphone-only audio option is enabled based on the location of the computing device.

8. A non-transitory computer readable storage medium encoded with instructions which, when executed, cause a processor of a computing device to:
receive an invitation from a host of an audio conference call to participate on the audio conference call executed by an application;
determine that the invitation has a headphone-only audio option enabled by a host of the audio conference call;
detect a headphone connected to an audio output interface; and
authorize a participant to join the audio conference call in response to detection of the headphone connected to the audio output interface.

9. The non-transitory computer readable storage medium of claim 8, wherein detection of the headphone is based on information exchanged with the headphone when the headphone is initially connected to the audio output interface.

10. The non-transitory computer readable storage medium of claim 8, the instructions further causing the processor to:
monitor audio output via audio signals captured by a microphone; and
disconnect the participant from the audio conference call when the microphone captures audio output generated from the audio conference call.

11. The non-transitory computer readable storage medium of claim 9, wherein a headphone-only audio driver is applied to an audio card of the computing device in response to the headphone-only audio option being enabled.

12. The non-transitory computer readable storage medium of claim 11, wherein the headphone-only audio driver is installed as part of an installation of the application on the computing device.

13. A non-transitory computer readable storage medium encoded with instructions which, when executed, cause a processor of a computing device to:
execute an application to host an audio conference call;
detect a location of the computing device;
determine that the location is a headphone-only location for the application;
enable a headphone-only audio option for the application in response to a determination that the location is a headphone-only location; and
authorize a participant to join the audio conference call via the application that is executed when a headphone is connected to the computing device.

14. The non-transitory computer readable storage medium of claim 13, wherein the location is determined based on a global positioning system (GPS).

15. The non-transitory computer readable storage medium of claim 13, wherein the location is determined based on a network identification of a wireless network connected to the computing device.
